(19) United States
(12) Patent Application Publication
(10) Pub. No.: US 2021/0116930 A1
(43) Pub. Date: Apr. 22, 2021

(54) INFORMATION PROCESSING APPARATUS, INFORMATION PROCESSING METHOD, PROGRAM, AND MOBILE OBJECT

(71) Applicant: SONY CORPORATION, TOKYO (JP)

(72) Inventor: YUKA ARIKI, TOKYO (JP)

(21) Appl. No.: 16/971,195

(22) PCT Filed: Jan. 16, 2019
(86) PCT No.: PCT/JP2019/001106

§ 371 Date: Aug. 19, 2020

(30) Foreign Application Priority Data
Feb. 28, 2018 (JP) 2018-035940

(51) Int. Cl. G05D 1/02; G06N 20/00; G06N 7/00; G05B 13/02; G01C 21/30; G01C 21/34; G01C 21/00

(52) U.S. Cl. CPC G05D 1/0221; G06N 20/00; G06N 7/005; G05D 1/0214; G01C 21/30; G01C 21/3453; G01C 21/3811; G05B 13/0265

(57) ABSTRACT

[Abstract] An information processing apparatus according to an aspect of the present technology includes an acquisition unit and a calculation unit. The acquisition unit acquires training data including course data related to a course along which a mobile object has moved. The calculation unit calculates a cost function related to movement of the mobile object through inverse reinforcement learning on the basis of the acquired training data.

### TECHNICAL FIELD

The present technology relates to an information processing apparatus, an information processing method, a program, and a mobile object that are applicable to mobile object movement control.

### BACKGROUND ART

Patent Literature 1 discloses a parking assistance system that generates a guidance route, guides the vehicle, and achieves driving assistance when a vehicle is moving on a narrow parking space or on a narrow road. The parking assistance system generates the guidance route on the basis of a predetermined safety margin, and achieves automatic guidance control. In this case, the safety margin is appropriately adjusted on a predetermined condition when it becomes difficult to guide the vehicle to a goal position due to existence of an obstacle or the like. This makes it possible to guide the vehicle to the goal position (see paragraphs [0040] to [0048], FIG. 5, and the like of Patent Literature 1).

### CITATION LIST

### Patent Literature

Patent Literature 1: JP 2017-30481A

### DISCLOSURE OF INVENTION

### Technical Problem

In future, it will be expected that technologies of automatically driving various mobile objects including vehicles may be widely used. Technologies capable of achieving flexible movement control tailored to an environment in which the mobile objects move have been desired.

In view of the circumstances as described above, a purpose of the present technology is to provide an information processing apparatus, an information processing method, a program, and a mobile object that are capable of achieving flexible movement control tailored to a movement environment.

### Solution to Problem

In order to achieve the above-described purpose, an information processing apparatus according to an aspect of the present technology includes an acquisition unit and a calculation unit.

The acquisition unit acquires training data including course data related to a course along which a mobile object has moved.

The calculation unit calculates a cost function related to movement of the mobile object through inverse reinforcement learning on the basis of the acquired training data.

The information processing apparatus calculates the cost function through the inverse reinforcement learning on the basis of the training data. This makes it possible to achieve the flexible movement control tailored to a movement environment.

The cost function may make it possible to generate a cost map by inputting information related to the movement of the mobile object.

The information related to the movement may include at least one of a position of the mobile object, surrounding information of the mobile object, or speed of the mobile object.

The calculation unit may calculate the cost function in such a manner that a predetermined parameter for defining the cost map is variable.

The calculation unit may calculate the cost function in such a manner that a safety margin is variable.

The information processing apparatus may further include an optimization processing unit that optimizes the calculated cost function through simulation.

The optimization processing unit may optimize the cost function on the basis of the acquired training data.

The optimization processing unit may optimize the cost function on the basis of course data generated through the simulation.

The optimization processing unit may optimize the cost function by combining the acquired training data with course data generated through the simulation.

The optimization processing unit may optimize the cost function on the basis of an evaluation parameter set by a user.

The optimization processing unit may optimize the cost function on the basis of at least one of a degree of approach to a destination, a degree of safety regarding movement, or a degree of comfort regarding the movement.

The calculation unit may calculate the cost function through Gaussian process inverse reinforcement learning (GPIRL).

The cost function may make it possible to generate a cost map based on a probability distribution.

The cost function may make it possible to generate a cost map based on a normal distribution. In this case, the cost map may be defined by a safety margin corresponding to an eigenvalue of a covariance matrix.

The cost map may be defined by a safety margin based on a movement direction of the mobile object.

The calculation unit may be capable of calculating the respective cost functions corresponding to different regions.

An information processing method according to an aspect of the present technology is an information processing method to be executed by a computer system, the information processing method including acquisition of training data including course data related to a course along which a mobile object has moved.

A cost function related to movement of the mobile object is calculated through inverse reinforcement learning on the basis of the acquired training data.

A program according to an aspect of the present technology causes a computer system to execute:

a step of acquiring training data including course data related to a course along which a mobile object has moved; and

a step of calculating a cost function related to movement of the mobile object through inverse reinforcement learning on the basis of the acquired training data.

A mobile object according to an aspect of the present technology includes an acquisition unit and a course calculation unit.

The acquisition unit acquires a cost function related to movement of the mobile object, the cost function having been calculated through inverse reinforcement learning on the basis of training data including course data related to a course along which the mobile object has moved.

The course calculation unit calculates a course on the basis of the acquired cost function.

The mobile object may be configured as a vehicle.

An information processing apparatus according to another aspect of the present technology includes an acquisition unit and a generation unit.

The acquisition unit acquires information related to movement of a mobile object.

The generation unit generates a cost map based on a probability distribution on the basis of the acquired information related to the movement of the mobile object.

### Advantageous Effects of Invention

As described above, according to the present technology, it is possible to achieve the flexible movement control tailored to a movement environment. Note that, the effects described herein are not necessarily limited and may be any of the effects described in the present disclosure.

### BRIEF DESCRIPTION OF DRAWINGS

FIG. 1 is a schematic diagram illustrating a configuration example of a movement control system according to the present technology.

FIG. 2 is external views illustrating a configuration example of a vehicle.

FIG. 3 is a block diagram illustrating a configuration example of a vehicle control system that controls the vehicle.

FIG. 4 is a block diagram illustrating a functional configuration example of a server apparatus.

FIG. 5 is a flowchart illustrating an example of generating a cost function by the server apparatus.

FIG. 6 is a schematic diagram illustrating an example of a cost map.

FIG. 7 is a schematic diagram illustrating an example of training data.

FIG. 8 is a schematic diagram illustrating an example of a cost map generated by means of a cost function calculated on the basis of the training data illustrated in FIG. 7.

FIG. 9 illustrates examples of simulation used for optimizing a cost function.

FIG. 10 illustrates examples of simulation used for optimizing a cost function.

FIG. 11 is diagrams for describing evaluation made on the present technology.

FIG. 12 is diagrams for describing evaluation made on the present technology.

FIG. 13 is diagrams for describing a course calculation method according to a comparative example.

### MODE(S) FOR CARRYING OUT THE INVENTION

Hereinafter, an embodiment of the present technology will be described with reference to the drawings.

[Configuration of Movement Control System]

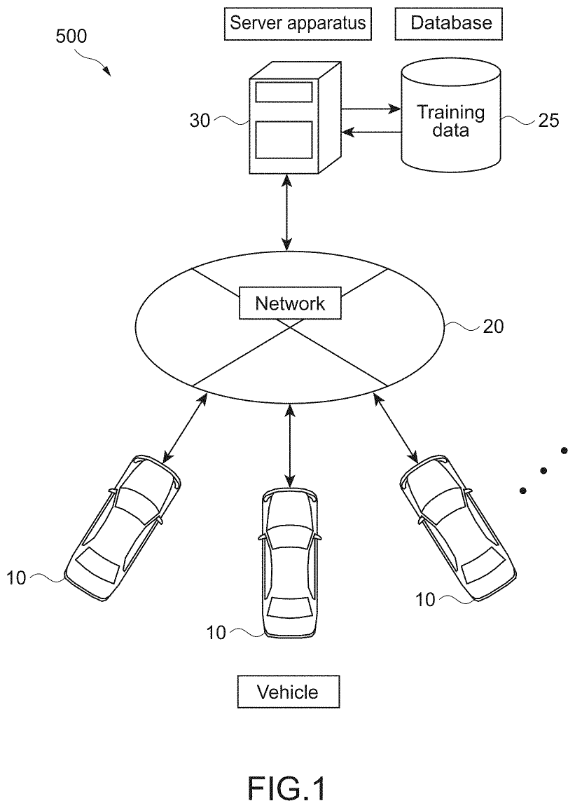

FIG. 1 is a schematic diagram illustrating a configuration example of a movement control system according to the present technology. A movement control system 500 includes a plurality of vehicles 10, a network 20, a database 25, and a server apparatus 30. Each of the vehicles 10 has an autonomous driving function capable of automatically driving to a destination. Note that, the vehicle 10 is an example of a mobile object according to the present embodiment.

The plurality of vehicles 10 and the server apparatus 30 are connected in such a manner that they are capable of communicating with each other via the network 20. The server apparatus 30 is connected to the database 25 in such a manner that the server apparatus 30 is capable of accessing the database 25. For example, the server apparatus 30 is capable of recording various kinds of information acquired from the plurality of vehicles 10 on the database 25, reading out the various kinds of information recorded on the database 25, and transmitting the information to each of the vehicles 10.

The network 20 is constructed of the Internet, a wide area communication network, and the like, for example. In addition, it is also possible to use any wide area network (WAN), any local area network (LAN), or the like. A protocol for constructing the network 20 is not limited.

According to the present embodiment, a so-called cloud service is provided by the network 20, the server apparatus 30, and the database 25. Therefore, it can be said that the plurality of vehicles 10 is connected to a cloud network.

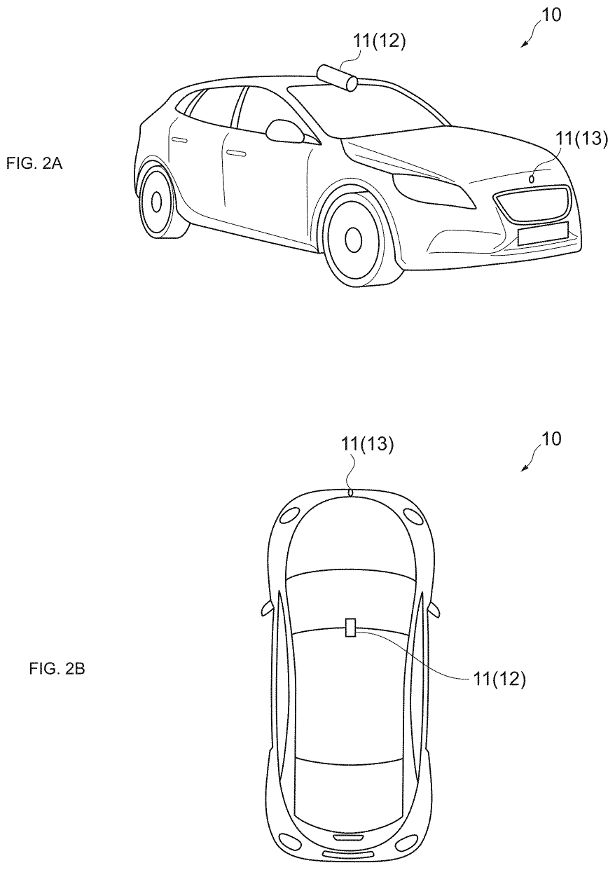

FIG. 2 is external views illustrating a configuration example of the vehicle 10. FIG. 2A is a perspective view illustrating the configuration example of the vehicle 10. FIG. 2B is a schematic diagram obtained when the vehicle 10 is viewed from above.

As illustrated in FIG. 2A and FIG. 2B, the vehicle 10 includes surrounding sensors 11. The surrounding sensors 11 detect surrounding information related to surroundings of the vehicle 10. Here, the surrounding information is information including image information, depth information, and the like regarding the surroundings of the vehicle 10. For example, distances to obstacles existing around the vehicle 10, the sizes of the obstacles, and the like are detected as the surrounding information. As an example of the surrounding sensors 11, FIG. 2A and FIG. 2B schematically illustrate an imaging apparatus 12 and a distance sensor 13.

The imaging apparatus 12 is installed in such a manner that the imaging apparatus 12 faces toward a front side of the vehicle 10. The imaging apparatus 12 captures an image of the front side of the vehicle 10 and detects image information. For example, an RGB camera or the like is used as the imaging apparatus 12. The RGB camera includes an image sensor such as a CCD or a CMOS. The present technology is not limited thereto. As the imaging apparatus 12, it is also possible to use an image sensor or the like that detects infrared light or polarized light.

The distance sensor 13 is installed in such a manner that the distance sensor 13 faces toward the front side of the vehicle 10. The distance sensor 13 detects information related to distances to objects included in its detection range, and detects depth information regarding the surroundings of the vehicle 10. For example, a Laser Imaging Detection and Ranging (LiDAR) sensor or the like is used as the distance sensor 13.

By using the LiDAR sensor, it is possible to easily detect image (depth image) with depth information or the like, for example. Alternatively, for example, it is also possible to use a Time-of-Fright (TOF) depth sensor or the like as the distance sensor 13. The types and the like of the distance sensors 13 are not limited. It is possible to use any sensor using a rangefinder, a millimeter-wave radar, an infrared laser, or the like.

In addition, the types, the number, and the like of the surrounding sensors 11 are not limited. For example, it is also possible to use surrounding sensors 11 (imaging apparatus 12 and distance sensor 13) installed in such a manner that the surrounding sensors 11 face toward any direction such as a rear side, a lateral side, or the like of the vehicle 10. Note that, the surrounding sensor 11 is constituted of a sensor included in a data acquisition unit 102 (to be described later).

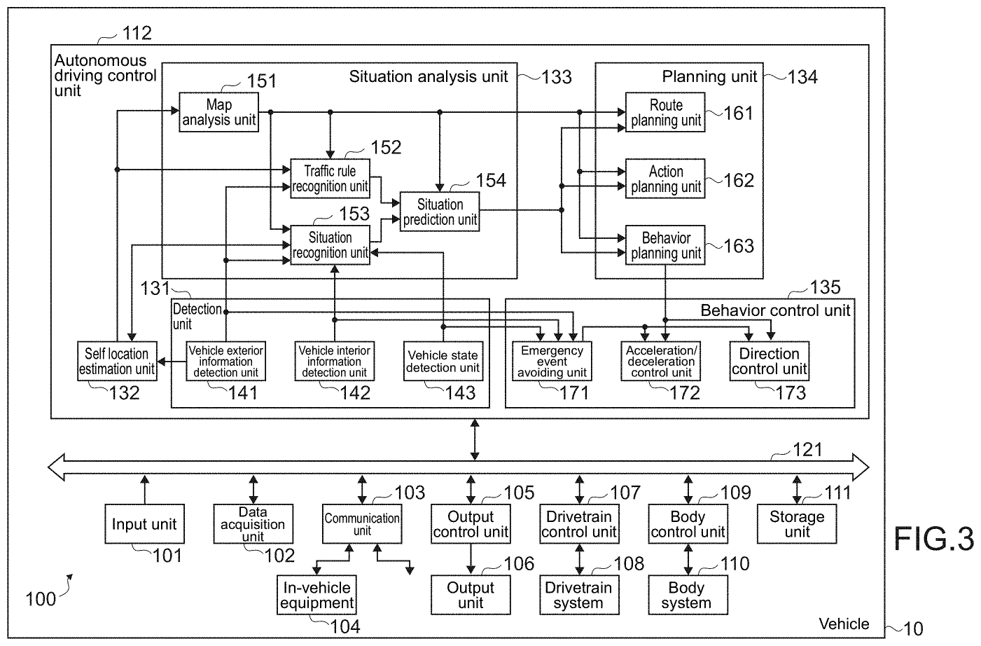

FIG. 3 is a block diagram illustrating a configuration example of a vehicle control system 100 that controls the vehicle 10. The vehicle control system 100 is a system that is installed in the vehicle 10 and that controls the vehicle 10 in various ways.

The vehicle control system 100 includes an input unit 101, a data acquisition unit 102, a communication unit 103, in-vehicle equipment 104, an output control unit 105, an output unit 106, a drivetrain control unit 107, a drivetrain system 108, a body control unit 109, a body system 110, a storage unit 111, and an autonomous driving control unit 112. The input unit 101, the data acquisition unit 102, the communication unit 103, the output control unit 105, the drivetrain control unit 107, the body control unit 109, the storage unit 111, and the autonomous driving control unit 112 are connected to each other via a communication network 121. For example, the communication network 121 includes a bus or a vehicle-mounted communication network compliant with any standard such as controller area network (CAN), local interconnect network (LIN), local area network (LAN), FlexRay, or the like. Note that, sometimes the structural elements of the vehicle control system 100 may be directly connected to each other without using the communication network 121.

Note that, the communication network 121 is not described in the case where the respective structural elements of the vehicle control system 100 communicate with each other via the communication network 121. For example, it is simply disclosed that the input unit 101 and the autonomous driving control unit 112 communicate with each other, in the case where the input unit 101 and the autonomous driving control unit 112 communicate with each other via the communication network 121.

The input unit 101 includes a device used by a passenger to input various kinds of data, instructions, or the like. For example, the input unit 101 includes an operation device such as a touchscreen, a button, a microphone, a switch, or a lever, an operation device capable of inputting information by sound, gesture, or the like that is different from manual operation, or the like. Alternatively, for example, the input unit 101 may be external connection equipment such as remote control equipment using infrared or another radio wave, or mobile equipment or wearable equipment compatible with operation of the vehicle control system 100. The input unit 101 generates an input signal on the basis of data, an instruction, or the like input from the passenger, and supplies the generated input signal to the respective structural elements of the vehicle control system 100.

The data acquisition unit 102 includes various kinds of sensors or the like for acquiring data to be used in processes performed by the vehicle control system 100, and supplies the acquired data to the respective structural elements of the vehicle control system 100.

For example, the data acquisition unit 102 includes various kinds of sensors for detecting state or the like of the vehicle 10. Specifically, for example, the data acquisition unit 102 includes a gyro sensor, an acceleration sensor, an inertial measurement unit (IMU), and a sensor or the like for detecting an amount of operation of an accelerator pedal, an amount of operation of a brake pedal, an steering angle of a steering wheel, the number of revolutions of an engine, the number of revolutions of a motor, rotational speeds of wheels, or the like.

In addition, for example, the data acquisition unit 102 includes various kinds of sensors for detecting information regarding the outside of the vehicle 10. Specifically, for example, the data acquisition unit 102 includes an imaging apparatus such as a time-of-flight (ToF) camera, a stereo camera, a monocular camera, an infrared camera, or other cameras. In addition, for example, the data acquisition unit 102 includes an environment sensor for detecting weather, a meteorological phenomenon, or the like, and a surrounding information detection sensor for detecting objects around the vehicle 10. For example, the environment sensor includes a raindrop sensor, a fog sensor, a sunshine sensor, a snow sensor, or the like. The surrounding information detection sensor includes an ultrasonic sensor, a radar, a LiDAR (light detection and ranging, laser imaging detection and ranging) sensor, a sonar, or the like.

In addition, for example, the data acquisition unit 102 includes various kinds of sensors for detecting a current location of the vehicle 10. Specifically, for example, the data acquisition unit 102 includes a global navigation satellite system (GNSS) receiver that receives satellite signals (hereinafter, referred to as GNSS signals) from a GNSS satellite that is a navigation satellite, or the like.

In addition, for example, the data acquisition unit 102 includes various kinds of sensors for detecting information regarding the inside of the vehicle 10. Specifically, for example, the data acquisition unit 102 includes an imaging apparatus that captures an image of a driver, a biological sensor that detects biological information of the driver, a microphone that collects sound within the interior of the vehicle, or the like. The biological sensor is, for example, installed in a seat surface, the steering wheel, or the like, and detects biological information of a passenger sitting on a seat or the driver holding the steering wheel.

The communication unit 103 communicates with the in-vehicle equipment 104, various kinds of equipment outside the vehicle, a server, a base station, or the like, transmits data supplied by the respective structural elements of the vehicle control system 100, and supplies the received data to the respective structural elements of the vehicle control system 100. Note that, a communication protocol supported by the communication unit 103 is not specifically limited. It is possible for the communication unit 103 to support plurality of types of communication protocols.

For example, the communication unit 103 establishes wireless connection with the in-vehicle equipment 104 by using a wireless LAN, Bluetooth (registered trademark), near field communication (NFC), wireless USB (WUSB), or the like. In addition, for example, the communication unit 103 establishes wired connection with the in-vehicle equipment 104 by using universal serial bus (USB), high-definition multimedia interface (HDMI), mobile high-definition link (MHL), or the like via a connection terminal (not illustrated) (and a cable if necessary).

In addition, for example, the communication unit 103 communicates with equipment (for example, an application server or a control server) existing on an external network (for example, the Internet, a cloud network, or a company-specific network) via a base station or an access point. In addition, for example, the communication unit 103 communicates with a terminal (for example, a terminal of a pedestrian or a store, or a machine type communication (MTC) terminal) existing in the vicinity of the vehicle 10 by using a peer to peer (P2P) technology. In addition, for example, the communication unit 103 carries out V2X communication such as vehicle-to-vehicle communication, vehicle-to-infrastructure communication, vehicle-to-home communication between the vehicle 10 and a home, or vehicle-to-pedestrian communication.

In addition, for example, the communication unit 103 includes a beacon receiver, receives a radio wave or an electromagnetic wave transmitted from a radio station installed on a road or the like, and thereby acquires information regarding the current location, congestion, traffic regulation, necessary time, or the like.

The in-vehicle equipment 104 includes mobile equipment or wearable equipment possessed by a passenger, information equipment carried into or attached to the vehicle 10, a navigation apparatus that searches for a pathway to any destination, and the like, for example.

The output control unit 105 controls output of various kinds of information to the passenger of the vehicle 10 or an outside of the vehicle 10. For example, the output control unit 105 generates an output signal that includes at least one of visual information (such as image data) or audio information (such as sound data), supplies the output signal to the output unit 106, and thereby controls output of the visual information and the audio information from the output unit 106. Specifically, for example, the output control unit 105 combines pieces of image data captured by different imaging apparatuses of the data acquisition unit 102, generates a bird's-eye image, a panoramic image, or the like, and supplies an output signal including the generated image to the output unit 106. In addition, for example, the output control unit 105 generates sound data including warning sound, a warning message, or the like with regard to danger such as collision, contact, or entrance into a danger zone, and supplies an output signal including the generated sound data to the output unit 106.

The output unit 106 includes an apparatus capable of outputting the visual information or the audio information to the passenger or the outside of the vehicle 10. For example, the output unit 106 includes a display apparatus, an instrument panel, an audio speaker, headphones, a wearable device such as an eyeglass type display worn by the passenger or the like, a projector, a lamp, or the like. Instead of an apparatus including a usual display, the display apparatus included in the output unit 106 may be, for example, an apparatus that displays the visual information within a field of view of the driver such as a head-up display, a transparent display, an apparatus having an augmented reality (AR) display function.

The drivetrain control unit 107 generates various kinds of control signals, supplies them to the drivetrain system 108, and thereby controls the drivetrain system 108. In addition, as necessary, the drivetrain control unit 107 supplies the control signals to the respective structural elements other than the drivetrain system 108 and notifies them of a control state of the drivetrain system 108 or the like.

The drivetrain system 108 includes various kinds of apparatuses related to the drivetrain of the vehicle 10. For example, the drivetrain system 108 includes a driving force generation apparatus for generating the driving force of an internal combustion engine, a driving motor, or the like, a driving force transmitting mechanism for transmitting the driving force to wheels, a steering mechanism for adjusting the steering angle, a braking apparatus for generating braking force, an anti-lock braking system (ABS), an electronic stability control (ESC) system, an electric power steering apparatus, and the like.

The body control unit 109 generates various kinds of control signals, supplies them to the body system 110, and thereby controls the body system 110. In addition, as necessary, the body control unit 109 supplies the control signals to the respective structural elements other than the body system 110, and notifies them of a control state of the body system 110 or the like.

The body system 110 includes various kinds of body apparatuses installed in a vehicle body. For example, the body system 110 includes a keyless entry system, a smart key system, a power window apparatus, a power seat, the steering wheel, an air conditioner, various kinds of lamps (such as headlamps, tail lamps, brake lights, direction-indicator lamps, and fog lamps, for example), and the like.

The storage unit 111 includes read only memory (ROM), random access memory (RAM), a magnetic storage device such as a hard disc drive (HDD), a semiconductor storage device, an optical storage device, a magneto-optical storage device, or the like, for example. The storage unit 111 stores various kinds of programs and data used by respective structural elements of the vehicle control system 100, or the like. For example, the storage unit 11 stores map data such as three-dimensional high-accuracy maps, global maps and local maps. The high-accuracy map is a dynamic map or the like. The global map has lower accuracy than the high-accuracy map but covers wider area than the high-accuracy map. The local map includes information regarding surroundings of the vehicle 10.

The autonomous driving control unit 112 performs control with regard to autonomous driving such as autonomous travel or driving assistance. Specifically, for example, the autonomous driving control unit 112 performs cooperative control intended to implement functions of an advanced driver assistance system (ADAS) which functions include collision avoidance or shock mitigation for the vehicle 10, following driving based on a following distance, vehicle speed maintaining driving, a warning of collision of the vehicle 10, a warning of deviation of the vehicle 10 from a lane, or the like. In addition, for example, it is also possible for the autonomous driving control unit 112 to perform cooperative control intended for autonomous driving that allows the vehicle to travel autonomously without depending on the operation performed by the driver or the like. The autonomous driving control unit 112 includes a detection unit 131, a self location estimation unit 132, a situation analysis unit 133, a planning unit 134, and a behavior control unit 135.

The autonomous driving control unit 112 includes hardware necessary for a computer such as a CPU, RAM, and ROM, for example. Various kinds of information processing methods are executed when the CPU loads a program into the RAM and executes the program. The program is recorded on the ROM in advance.

The specific configuration of the autonomous driving control unit 112 is not limited. For example, it is possible to use a programmable logic device (PLD) such as a field programmable gate array (FPGA), or another device such as an application specific integrated circuit (ASIC).

As illustrated in FIG. 2, the autonomous driving control unit 112 includes a detection unit 131, a self location estimation unit 132, a situation analysis unit 133, a planning unit 134, and the behavior control unit 135. For example, each of the functional blocks is configured when the CPU of the autonomous driving control unit 112 executes a predetermined program.

The detection unit 131 detects various kinds of information that is necessary to control autonomous driving. The detection unit 131 includes a vehicle exterior information detection unit 141, a vehicle interior information detection unit 142, and a vehicle state detection unit 143.

The vehicle exterior information detection unit 141 performs a process of detecting information regarding an outside of the vehicle 10 on the basis of data or signals from the respective units of the vehicle control system 100. For example, the vehicle exterior information detection unit 141 performs a detection process, a recognition process, a tracking process of objects around the vehicle 10, and a process of detecting distances to the objects. Examples of a detection target object include a vehicle, a person, an obstacle, a structure, a road, a traffic light, a traffic sign, a road sign, and the like. In addition, for example, the vehicle exterior information detection unit 141 performs a process of detecting an ambient environment around the vehicle 10. Examples of the ambient environment serving as a detection target include weather, temperature, humidity, brightness, a road surface condition, and the like. The vehicle exterior information detection unit 141 supplies data indicating results of the detection processes to the self location estimation unit 132, a map analysis unit 151, a traffic rule recognition unit 152, and a situation recognition unit 153 of the situation analysis unit 133, an emergency event avoiding unit 171 of the behavior control unit 135, and the like.

In addition, according to the present embodiment, the vehicle exterior information detection unit 141 generates learning data to be used for machine learning. Accordingly, the vehicle exterior information detection unit 141 is capable of performing both a process of detecting information regarding the outside of the vehicle 10 and a process of generating the learning data.

The vehicle interior information detection unit 142 performs a process of detecting information regarding an inside of the vehicle on the basis of data or signals from the respective units of the vehicle control system 100. For example, the vehicle interior information detection unit 142 performs processes of authenticating and detecting the driver, a process of detecting a state of the driver, a process of detecting a passenger, a process of detecting a vehicle interior environment, and the like. Examples of the state of the driver, which is a detection target, include a health condition, a degree of consciousness, a degree of concentration, a degree of fatigue, a gaze direction, and the like. Examples of the vehicle interior environment, which is a detection target, include temperature, humidity, brightness, smell, and the like. The vehicle interior information detection unit 142 supplies data indicating results of the detection processes to the situation recognition unit 153 of the situation analysis unit 133, the emergency event avoiding unit 171 of the behavior control unit 135, and the like.

The vehicle state detection unit 143 performs a process of detecting a state of the vehicle 10 on the basis of data or signals from the respective units of the vehicle control system 100. Examples of the state of the vehicle 10, which is a detection target, include speed, acceleration, a steering angle, presence/absence of abnormality, a content of the abnormality, a state of driving operation, a position and inclination of the power seat, a state of a door lock, states of other in-vehicle equipment, and the like. The vehicle state detection unit 143 supplies data indicating results of the detection process to the situation recognition unit 153 of the situation analysis unit 133, the emergency event avoiding unit 171 of the behavior control unit 135, and the like.

The self location estimation unit 132 performs a process of estimating a location, a posture, and the like of the vehicle 10 on the basis of data or signals from the respective units of the vehicle control system 100 such as the vehicle exterior information detection unit 141 and the situation recognition unit 153 of the situation analysis unit 133. In addition, as necessary, the self location estimation unit 132 generates a local map (hereinafter, referred to as a self location estimation map) to be used for estimating a self location. For example, the self location estimation map may be a high-accuracy map using a technology such as simultaneous localization and mapping (SLAM). The self location estimation unit 132 supplies data indicating a result of the estimation process to the map analysis unit 151, the traffic rule recognition unit 152, and the situation recognition unit 153 of the situation analysis unit 133, and the like. In addition, the self location estimation unit 132 causes the storage unit 111 to store the self location estimation map.

Hereinafter, sometimes the process of estimating the location, the posture, and the like of the vehicle 10 may be referred to as self location estimation processing. In addition, the information regarding the location and the posture of the vehicle 10 may be referred to as location/posture information. Therefore, the self location estimation processing executed by the self location estimation unit 132 is the process of estimating the location/posture information of the vehicle 10.

The situation analysis unit 133 performs a process of analyzing a situation of the vehicle 10 and a situation around the vehicle 10. The situation analysis unit 133 includes the map analysis unit 151, the traffic rule recognition unit 152, the situation recognition unit 153, and a situation prediction unit 154.

The map analysis unit 151 performs a process of analyzing various kinds of maps stored in the storage unit 111 and constructs a map including information necessary for an autonomous driving process while using data or signals from the respective units of the vehicle control system 100 such as the self location estimation unit 132 and the vehicle exterior information detection unit 141 as necessary. The map analysis unit 151 supplies the constructed map to the traffic rule recognition unit 152, the situation recognition unit 153, the situation prediction unit 154, and the like as well as a route planning unit 161, an action planning unit 162, and a behavior planning unit 163 of the planning unit 134.

The traffic rule recognition unit 152 performs a process of recognizing traffic rules around the vehicle 10 on the basis of data or signals from the respective units of the vehicle control system 100 such as the self location estimation unit 132, the vehicle exterior information detection unit 141, and the map analysis unit 151. The recognition process makes it possible to recognize locations and states of traffic lights around the vehicle 10, contents of traffic controls around the vehicle 10, a drivable lane, and the like, for example. The traffic rule recognition unit 152 supplies data indicating a result of the recognition process to the situation prediction unit 154 or the like.

The situation recognition unit 153 performs a process of recognizing situations related to the vehicle 10 on the basis of data or signals from the respective units of the vehicle control system 100 such as the self location estimation unit 132, the vehicle exterior information detection unit 141, the vehicle interior information detection unit 142, the vehicle state detection unit 143, and the map analysis unit 151. For example, the situation recognition unit 153 performs a process of recognizing a situation of the vehicle 10, a situation around the vehicle 10, a situation of the driver of the vehicle 10, and the like. In addition, as necessary, the situation recognition unit 153 generates a local map (hereinafter, referred to as a situation recognition map) to be used for recognizing the situation around the vehicle 10. For example, the situation recognition map may be an occupancy grid map.

Examples of the situation of the vehicle 10, which is a recognition target, include a location, a posture, and movement (such as speed, acceleration, or a movement direction, for example) of the vehicle 10, presence/absence of abnormality, contents of the abnormality, and the like. Examples of the situation around the vehicle 10, which is a recognition target, include types and locations of surrounding still objects, types, locations, and movement (such as speed, acceleration, and movement directions, for example) of surrounding moving objects, compositions of surrounding roads, conditions of road surfaces, ambient weather, temperature, humidity, brightness, and the like. Examples of the state of the driver, which is a detection target, include a health condition, a degree of consciousness, a degree of concentration, a degree of fatigue, a gaze direction, driving operation, and the like.

The situation recognition unit 153 supplies data indicating a result of the recognition process (including the situation recognition map as necessary) to the self location estimation unit 132 and the situation prediction unit 154. In addition, the situation recognition unit 153 causes the storage unit 111 to store the situation recognition map.

The situation prediction unit 154 performs a process of predicting a situation related to the vehicle 10 on the basis of data or signals from the respective units of the vehicle control system 100 such as the map analysis unit 151, the traffic rule recognition unit 152, and the situation recognition unit 153. For example, the situation prediction unit 154 performs a process of predicting a situation of the vehicle 10, a situation around the vehicle 10, a situation of the driver, and the like.

Examples of the situation of the vehicle 10, which is a prediction target, include behavior of the vehicle 10, occurrence of abnormality, a drivable distance, and the like. Examples of the situation around the vehicle 10, which is a prediction target, include behavior of moving objects, change in states of traffic lights, change in environments such as weather, and the like around the vehicle 10. Examples of the situation of the driver, which is a prediction target, include behavior, a health condition, and the like of the driver.

The situation prediction unit 154 supplies data indicating a result of the prediction process to the route planning unit 161, the action planning unit 162, the behavior planning unit 163 and the like of the planning unit 134 in addition to the data from the traffic rule recognition unit 152 and the situation recognition unit 153.

The route planning unit 161 plans a route to a destination on the basis of data or signals from the respective units of the vehicle control system 100 such as the map analysis unit 151 and the situation prediction unit 154. For example, the route planning unit 161 sets a goal pathway on the basis of the global map. The goal pathway is a route from a current location to a designated destination. In addition, for example, the route planning unit 161 appropriately changes the route on the basis of a health condition of a driver, a situation such as congestion, an accident, traffic regulation, and road work, etc. The route planning unit 161 supplies data representing the planned route to the action planning unit 162 or the like.

According to the present embodiment, the server apparatus 30 transmits a cost function related to movement of the vehicle 10 to the autonomous driving control unit 112 via the network 20. The route planning unit 161 calculates a course along which the vehicle 10 should move on the basis of the received cost function, and appropriately reflects the calculated course in the route plan.

For example, a cost map is generated by inputting information related to the movement of the vehicle 10 into the cost function. Examples of the information related to the movement of the vehicle 10 include the location of the vehicle 10, surrounding information of the vehicle 10, and the speed of the vehicle 10. Of course, the information is not limited thereto. It is also possible to use any information related to movement of the vehicle 10. Sometimes it is possible to use one of pieces of the information.

A course with the minimum cost is calculated on the basis of the calculated cost map. Note that, the cost map may be deemed as a concept included in the cost function. Therefore, it is also possible to calculate the course with the minimum cost by inputting the information related to the movement of the vehicle 10 into the cost function.

The type of cost to be calculated is not limited. Any type of cost may be set. For example, it is possible to set any cost such as a dynamic obstacle cost, a static obstacle cost, a cost corresponding to the type of an obstacle, a goal speed following cost, a goal pathway following cost, a speed change cost, a steering change cost, or a combination thereof.

For example, it is possible to appropriately set a cost to calculate a course that satisfies a driving mode desired by the user. For example, the cost is appropriately set to calculate a course that satisfies a degree of approach to a destination, a degree of safety regarding movement, a degree of comfort regarding the movement, or the like desired by the user. Note that, the above-described degree of approach to the destination and the like are concepts referred to as evaluation parameters of the user to be used when cost function optimization (to be described later) is executed. Details of such concepts will be described later.

It is possible to appropriately set a cost to be calculated by appropriately setting a parameter that defines the cost function (cost map). For example, it is possible to calculate an obstacle cost by appropriately setting a distance to an obstacle, speed and a direction of an own vehicle, and the like as parameters. In addition, it is possible to calculate a goal following cost by appropriately setting a distance to a goal pathway as a parameter. Of course, setting of parameters is not limited to the above-described setting.

The movement control system 500 according to the present embodiment calculates a course with the smallest cost by inputting information related to movement of the vehicle 10 into a cost function in the case where any type of cost is set, that is, in the case where any type of parameter is set as a parameter for defining the cost function (cost map). Details thereof will be described later.

The action planning unit 162 plans actions of the vehicle 10 for achieve safe driving along a route planned by the route planning unit 161 within a planned period of time, on the basis of data or signals from the respective units of the vehicle control system 100 such as the map analysis unit 151 and the situation prediction unit 154. For example, the action planning unit 162 plans a start of movement, a stop of movement, a movement direction (e.g., forward, reverse, left turn, right turn, change in direction, or the like), a driving lane, driving speed, overtaking, or the like. The action planning unit 162 supplies data representing the planned actions of the vehicle 10 to the behavior planning unit 163 or the like.

The behavior planning unit 163 plans behavior of the vehicle 10 for performing the actions planned by the action planning unit 162, on the basis of data or signals from the respective units of the vehicle control system 100 such as the map analysis unit 151 and the situation prediction unit 154. For example, the behavior planning unit 163 plans acceleration, deceleration, a driving course, or the like. The behavior planning unit 163 supplies data representing the planned behavior of the vehicle 10 to an acceleration/deceleration control unit 172, a direction control unit 173, and the like of the behavior control unit 135.

The behavior control unit 135 controls behavior of the vehicle 10. The behavior control unit 135 includes the emergency event avoiding unit 171, the acceleration/deceleration control unit 172, and the direction control unit 173.

The emergency event avoiding unit 171 performs a process of detecting an emergency event such as collision, contact, entrance into a danger zone, abnormality in a condition of the driver, or abnormality in a condition of the vehicle 10 on the basis of detection results obtained by the vehicle exterior information detection unit 141, the vehicle interior information detection unit 142, and the vehicle state detection unit 143. In the case where occurrence of the emergency event is detected, the emergency event avoiding unit 171 plans behavior of the vehicle 10 such as a quick stop or a quick turn for avoiding the emergency event. The emergency event avoiding unit 171 supplies data indicating the planned behavior of the vehicle 10 to the acceleration/deceleration control unit 172, the direction control unit 173, and the like.

The acceleration/deceleration control unit 172 controls acceleration/deceleration to achieve the behavior of the vehicle 10 planned by the behavior planning unit 163 or the emergency event avoiding unit 171. For example, the acceleration/deceleration control unit 172 computes a control goal value of the driving force generation apparatus or the braking apparatus to achieve the planned acceleration, deceleration, or quick stop, and supplies a control instruction indicating the computed control goal value to the drivetrain control unit 107.

The direction control unit 173 controls a direction to achieve the behavior of the vehicle 10 planned by the behavior planning unit 163 or the emergency event avoiding unit 171. For example, the direction control unit 173 computes a control goal value of the steering mechanism to achieve a driving course or quick turn planned by the behavior planning unit 163 or the emergency event avoiding unit 171, and supplies a control instruction indicating the computed control goal value to the drivetrain control unit 107.

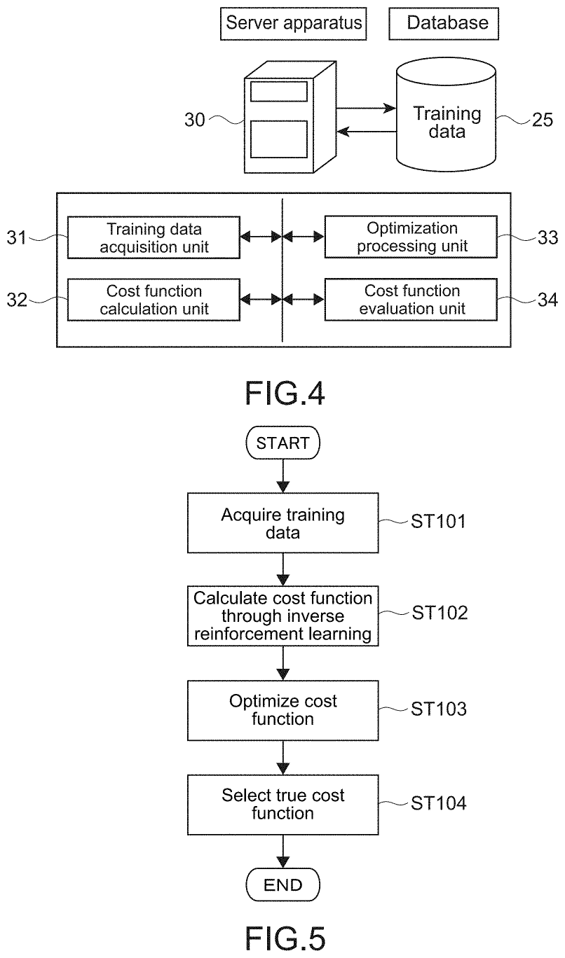

FIG. 4 is a block diagram illustrating a functional configuration example of the server apparatus 30. FIG. 5 is a flowchart illustrating an example of generating a cost function by the server apparatus 30.

The server apparatus 30 includes hardware that is necessary for configuring a computer such as a CPU, ROM, RAM, and an HDD, for example. Respective blocks illustrated in FIG. 4 are configured and an information processing method according to the present technology is executed when the CPU loads a program into the RAM and executes the program. The program relates to the present technology and is recorded on the ROM or the like in advance.

For example, the server apparatus 30 can be implemented by any computer such as a personal computer (PC). Of course, it is also possible to use hardware such as an FPGA or an ASIC. In addition, it is also possible to use dedicated hardware such as an integrated circuit (IC) to implement the respective blocks illustrated in FIG. 4.

The program is installed in the server apparatus 30 via various kinds of recording media, for example. Alternatively, it is also possible to install the program via the Internet.

As illustrated in FIG. 4, the server apparatus 30 includes a training data acquisition unit 31, a cost function calculation unit 32, an optimization processing unit 33, and a cost function evaluation unit 34.

The training data acquisition unit 31 acquires training data for calculating a cost function from the database 25 (Step 101). The training data includes course data related to a course along which each vehicle 10 has moved. In addition, the training data also includes movement situation information related to a state of the vehicle 10 obtained when the vehicle 10 has moved along the course. Examples of the movement situation information may include any information such as information regarding a region where the vehicle 10 has moved, speed and an angle of the moving vehicle 10 obtained when the vehicle 10 has moved, surrounding information of the vehicle 10 (presence or absence of an obstacle, a distance to the obstacle, and the like), color information of a road, time information, or weather information.

Typically, information that makes it possible to extract a parameter that defines a cost function (cost map) is acquired as the movement situation information and is used as the training data. Of course, as the movement situation information, it is possible to acquire the parameter itself that defines the cost function (cost map).

According to the present embodiment, movement information including the movement situation information and the course data related to courses through which the vehicles 10 have moved are appropriately collected in the server apparatus from the vehicles 10 via the network 20. The server apparatus 30 stores the received movement information in the database 25. The movement information collected from respective vehicles 10 may be usable as the training data without any change. Alternatively, it is also possible to appropriately generate the training data on the basis of the received movement information. According to the present embodiment, the training data acquisition unit corresponds to an acquisition unit.

The cost function calculation unit 32 calculates a cost function related to movement of a mobile object through inverse reinforcement learning (IRL) on the basis of the acquired training data (Step 102). Through the inverse reinforcement learning, the cost function is calculated in such a manner that course data included in the training data is a course with the minimum cost. According to the present embodiment, the cost function is calculated through Gaussian process inverse reinforcement learning (GPIRL).

It is possible to calculate a cost function with regard to each piece of the course data usable as the training data. In other words, a cost function is calculated through the inverse reinforcement learning with regard to a piece of the course data (training data). Of course, the present technology is not limited thereto. It is also possible to calculate a cost function with regard to a plurality of pieces of course data included in the training data. According to the present embodiment, the cost function calculation unit corresponds to a calculation unit.

Note that, calculation of a course with the minimum cost corresponds to calculation of a cost with the maximum reward. Therefore, calculation of a cost function corresponds to calculation of a reward function that makes it possible to calculate reward with regard to cost. Hereinafter, sometimes the calculation of the cost function will be referred to as the calculation of the reward function.

The optimization processing unit 33 optimizes the calculated cost function (Step 103). According to the present embodiment, the cost function is optimized through simulation. In other words, the vehicle is moved in a preset virtual space by using the calculated cost function. The cost function is optimized on the basis of such simulation.

The cost function evaluation unit 34 evaluates the optimized cost functions, and selects a cost function with the highest performance as a true cost function (Step 104). For example, scores are given to the cost functions on the basis of simulation results. The true cost function is calculated on the basis of the scores. Of course, the present technology is not limited thereto.

According to the present embodiment, a cost function generator is implemented by the cost function calculation unit 32, the optimization processing unit 33, and the cost function evaluation unit 34.

Next, details of the respective steps illustrated in FIG. 5 will be described. The steps illustrated in FIG. 5 are executed by the respective blocks illustrated in FIG. 4.

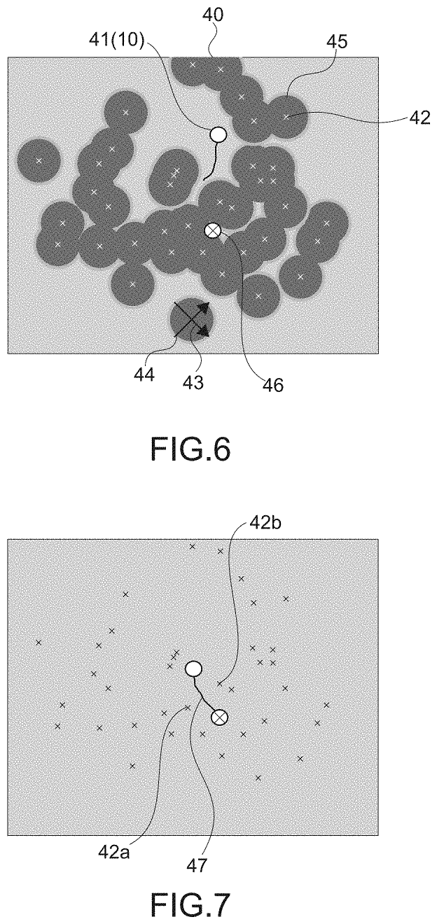

FIG. 6 is a schematic diagram illustrating an example of the cost map. For example, a two-dimensional normal distribution where n=2 is set with regard to the following expression on the basis of obstacles 42 (indicated by cross marks) existing around the vehicle 10 at a starting point 41.

$$f ( x ) = \frac{1}{{( \sqrt{2 π} )}^{n} \sqrt{\vert \sum \vert}} exp \{ - \frac{1}{2} {( x - μ )}^{T} {\sum }^{- 1} ( x - μ ) \} \qquad [ Math . 1 ]$$

Since the two-dimensional normal distribution is set, the covariance matrix Σ in the expression is a 2×2 matrix, and includes two eigenvalues and two eigenvectors 43 and 44 that are orthogonal to each other. Here, if the covariance matrix Σ is defined as a symmetric matrix, the covariance matrix Σ includes only one eigenvalue, and an equiprobability ellipse (concentration ellipse) has a circular shape.

In a cost map 40, the equiprobability ellipse is set as a safety margin 45. In other words, the cost map 40 is a cost map based on the normal distribution in which the safety margins 45 are defined. The safety margins 45 correspond to the eigenvalue of the covariance matrix Z.

Note that, the safety margin 45 is a parameter related to a distance to the obstacle. A position out of the radius of the safety margin 45 means a safe position (with the minimum cost, for example), and a region within the safety margin 45 means a dangerous region (with the maximum cost, for example). In other words, a course that does not pass through the safety margin 45 is a course with a small cost.

For example, information including positions of obstacles around the vehicle 10 is input to the cost function as information related to movement of the vehicle 10. This makes it possible to generate the cost map 40 in which the safety margins 45 having sizes corresponding to the eigenvalues of the covariance matrix are set. Note that, in FIG. 6, the safety margins 45 having the same size are set with regard to all the obstacles 42. However, it is also possible to set safety margins 45 of different sizes with regard to the respective obstacles 42.

With reference to the cost map 40 illustrated in FIG. 6, it is impossible to calculate a course that does not pass through the safety margins 45 from the starting point 41 to a destination 46. In other words, with regard to the cost map 40 illustrated in FIG. 6, it is difficult to calculate an appropriate course from the starting point 41 to the destination 46.

FIG. 7 is a schematic diagram illustrating an example of the training data. For example, it is assumed that training data illustrated in FIG. 7 is acquired. Here, to simplify the explanation, it is assumed that training data including course data of a course 47 for passing through a space between obstacles 42a and 42b is acquired in a state where there are obstacles 42 at the same positions as the obstacles 42 illustrated in FIG. 6A. The cost function calculation unit 32 calculates a cost function through the GPIRL on the basis of the training data.

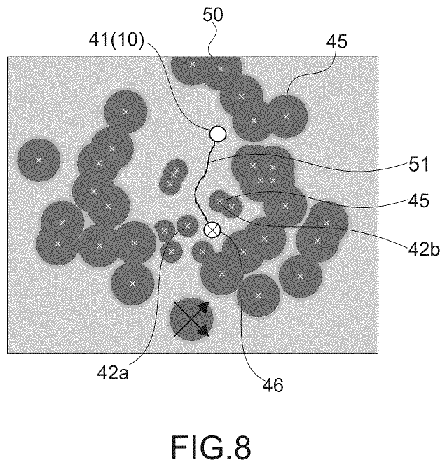

FIG. 8 is a schematic diagram illustrating an example of a cost map 50 generated by means of a cost function calculated on the basis of the training data illustrated in FIG. 7. The cost function is calculated (learned) by using the course data of a course along which the vehicle 10 actually has passed through the space between the obstacles 42a and 42b as the training data. As a result, the sizes (the eigenvalues of the covariance matrix) of the safety margins 45 set for the obstacles 42a and 42b are adjusted, and this makes it possible to calculate an appropriate course 51 from the starting point 41 to the destination 46.

In other words, the cost function is learned on the basis of relations between distances to the obstacles 42 and the course along which the vehicle 10 could have actually moved, and the cost map 50 having improved accuracy is generated. Note that, optimization of the safety margins are also executed appropriately with regard to the obstacles 42 other than the obstacle 42a or the obstacle 42b.

Note that, FIG. 7 illustrates the example of the training data that is in the state where there are obstacles 42 at the same positions as the obstacles 42 illustrated in FIG. 6. The present technology is not limited thereto. It is also possible to use course data regarding another place having a different surrounding situation, as the training data. By using such training data, it is also possible to learn a cost function on the basis of relations between distances to the obstacles and a course along which the vehicle 10 could have actually moved, for example.

In other words, it is possible to learn a cost function on the basis of actual course data indicating that it is possible to pass through space between obstacles placed at a certain interval, regardless of a location or the like. This makes it possible to improve accuracy of the cost map.

In the cost maps 40 and 50, the safety margins correspond to parameters that define the cost maps (cost functions). By executing the inverse reinforcement learning on the basis of the training data, it is possible to calculate a cost function in such a manner that the safety margins 45 are variable.

The same applies to any parameters that define a cost map (cost function). In other words, according to the present technology, it is possible to calculate a cost function in such a manner that any parameters that define a cost map (cost function) are variable. This makes it possible to generate an appropriate cost function (cost map) tailored to a movement environment and achieve flexible movement control.

For example, by using a cost map in which safety margins are fixed, it is very difficult to calculate a course at a crowded intersection or the like where many pedestrians, vehicles, and the like pass. However, according to the present embodiment, it is possible to learn a cost function on the basis of training data including course data that indicates actual courses along which the vehicles or the like have crossed the crowded intersection, for example. This makes it possible to appropriately generate a cost map in which safety margins are optimized, and this makes it possible to calculate an appropriate course.

Next, a specific algorithm example of the reward function obtained through the GPIRL will be described. As described above, calculation of a reward function corresponds to calculation of a cost function.

First, as indicated by the following expression, the following expression represents a reward function r(s) of a state s through linear imaging of a nonlinear function. The state s may be defined by any parameters related to a current state such as a grid position of a grid map, speed, a direction, and the like of the vehicle 10, for example.

r(s)=αϕ(s) [Math. 2]

where α=[α₁ . . . α_{d}],ϕ(s)=[ϕ₁(s) . . . ϕ_{d}(s)]^{T}

φ_{d}(x) is a function indicating a feature quantity corresponding a parameter that defines the cost function. For example, φ_{d}(x) is set in accordance with each of any parameters such as a distance to an obstacle, speed of the vehicle 10, and a parameter representing ride comfort. The respective feature quantities are weighted by a.

The following expression is obtained by executing the GPIRL.

log P(D,u,θ|Xu)=log P(D|r=K_{r,u}^{T}K_{u,u}⁻¹u)+log P(u,θ|Xu) [Math. 3]

D represents course data included in training data. Xu is a feature quantity derived from the state S included in the training data, and Xu corresponds to the feature quantity φ_{d}(x).

u represents a parameter set as virtual reward. As indicated by the above expression, it is possible to use kernel functions to efficiently calculate the reward function r as mean and variance of a Gaussian distribution through a non-linear regression method called a Gaussian process.

As indicated by the following expression, θ is a parameter for defining an element k(uᵢ,uⱼ) of a matrix K_{U,U}, and θ={β,Λ} is obtained.

k(uᵢ,uⱼ)=β exp(−½(uᵢ−uⱼ))^{T}Λ(uᵢ−uⱼ)) [Math. 4]

According to the present embodiment, a reward function r(s) is calculated in such a manner that log P(D|r), which is a first term of the expression [Math. 3], becomes maximum. This means that parameters (u,θ) are adjusted in such a manner that log P(D|r), which is the first term, becomes maximum. To adjust the parameters (u,θ), a probability model such as a Markov decision process (MDP), a gradient method, or the like may be appropriately used, for example.

In the examples illustrated in FIG. 6 to FIG. 8, the following reward function r(s) is obtained on the basis of a feature quantity (referred to as “φ distance(x)”) related to a distance (safety margin). Note that, the number of nonlinear functions is 1. Therefore, 1 is used as a weight.

r(s)=φ distance(s)

Rewards are calculated by means of the reward function r(s) with regard to all the states s (here, positions on a grid) in the grid map (not illustrated). This makes it possible to calculate a course with the maximum reward.

For example, the GPIRL is executed on the basis of the training data illustrated in FIG. 7. The parameters (u,θ) are adjusted on the basis of the feature quantities (Xu) derived from the states s included in the training data in such a manner that the course 47 (corresponding to D) has the maximum reward. As a result, the safety margins 45 (eigenvalues of the covariance matrix) set for the obstacles 42 are adjusted. Here, adjustment of the safety margins 45 corresponds to adjustment of Λ in the parameter θ.

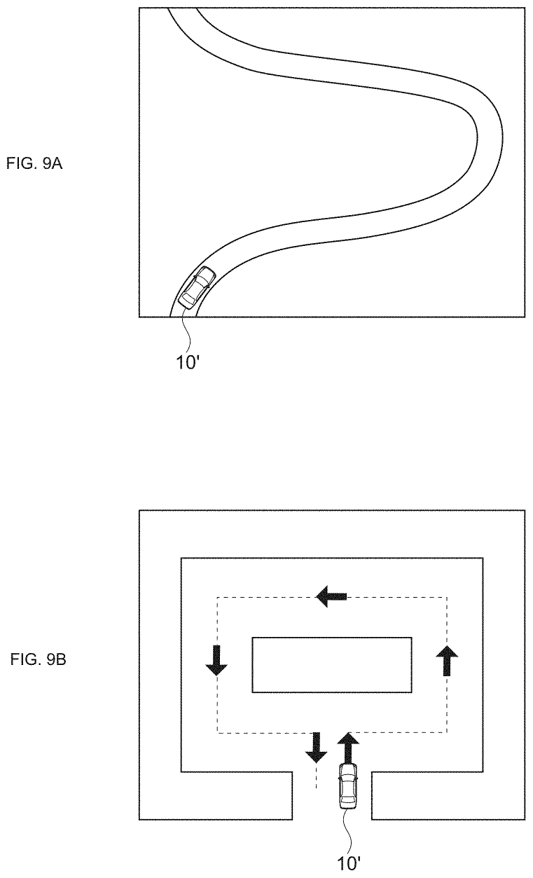

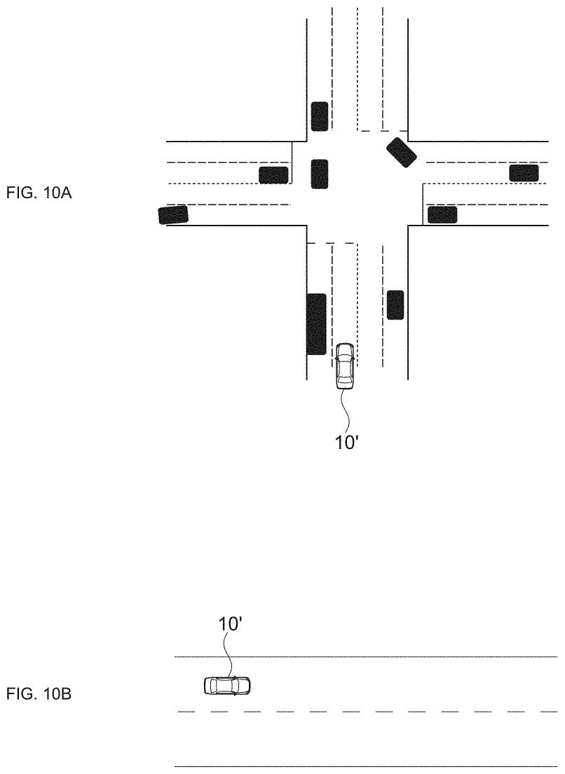

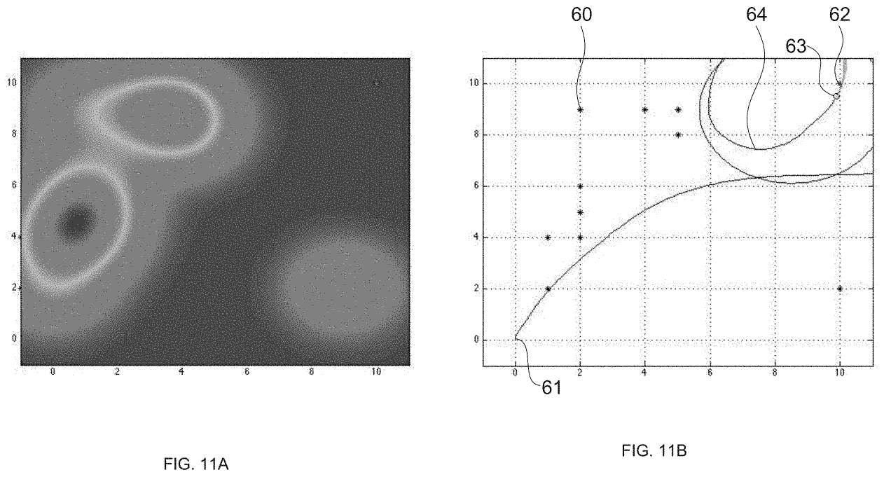

FIG. 9 and FIG. 10 are examples of simulation used for optimizing a cost function by the optimization processing unit 33. For example, a vehicle 10′ is virtually moved in a simulation environment that assumes various situations by using the cost function (reward function) calculated through the GPIRL.

For example, simulation is done on an assumption of traveling along an S-shaped road illustrated in FIG. 9A, or traveling around an obstacle in a counterclockwise direction as illustrated in FIG. 9B. In addition, simulation is done on an assumption of going straight down an intersection where other vehicles are traveling as illustrated in FIG. 10A, or on an assumption of changing lanes on a freeway. Of course, it is also possible to set any other simulation environments.

According to such simulation, a course is calculated by means of the calculated cost function. In other words, costs for the respective states S are calculated by means of the cost function, and a course with the minimum cost is calculated.

For example, it is assumed that the vehicle has not been appropriately moved in the respective simulations, that is, appropriate courses have not been calculated. In this case, according to the present embodiment, the optimization processing unit 33 optimizes the cost function. For example, the cost function is optimized in such a manner that appropriate courses are calculated in the respective simulations.

For example, the cost function is optimized in such a manner that the appropriate courses in the respective simulations have small costs (have large rewards). According to the present embodiment, the parameters (u,θ) that have already been adjusted when the GPIRL has been executed is adjusted again. Therefore, the optimization is also referred to as relearning.

For example, it is possible to optimize the cost function on the basis of autonomously generated data in the respective simulations (course data generated in the simulations). Alternatively, it is also possible to optimize the cost function on the basis of training data stored in the database 25. In addition, it is also possible to optimize the cost function by means of a combination of the training data and the autonomously generated data in the simulations.

For example, the autonomously generated data and the training data are screened, and the cost function is optimized on the basis of a selected piece of the autonomously generated data or a selected piece of the training data. For example, a small weight may be attached to a course along which the vehicle has not moved appropriately, a large weight may be attached only to an appropriate course, and then relearning may be performed.

In addition, it is also possible to optimize the cost function on the basis of an evaluation parameter set by a user. The evaluation parameter set by the user may be a degree of approach to a destination, a degree of safety regarding movement, a degree of comfort regarding the movement, or the like, for example. Of course, it is also possible to adopt other evaluation parameters.

The degree of approach to a destination includes time it takes to arrive at the destination (arrival time), for example. In the case where this evaluation parameter is set, the cost function is optimized in such a manner that a course with an early arrival time has a small cost in each simulation. Alternatively, a course with an early arrival time is selected from the course data included in the training data or the autonomously generated data in the simulations, and the cost function is optimized in such a manner that the course has a small cost.

The degree of safety regarding movement is an evaluation parameter related to a distance to an obstacle, for example. For example, the cost function is optimized in such a manner that a course that sufficiently avoids the obstacle in each simulation has a small cost. Alternatively, a course that sufficiently avoids the obstacle is selected from the training data or the autonomously generated data in the simulations, and the cost function is optimized in such a manner that the course has a small cost.

The degree of comfort regarding movement may be defined by acceleration, jerk, vibration, operational feeling, or the like acting on a driver depending on the movement, for example. The acceleration includes uncomfortable acceleration and comfortable acceleration generated by speeding up or the like. Such parameters may define comfort of driving performance on a freeway, comfort of driving performance in an urban area, and the like as degrees of comfort.

The cost function is optimized in such a manner that a course having a high degree of comfort regarding movement in each simulation has a small cost. Alternatively, a course having a high degree of comfort regarding movement is extracted from the training data or the autonomously generated data in the simulations, and the cost function is optimized in such a manner that the course has a small cost.

It is also possible to prepare appropriate simulations corresponding to the respective evaluation parameters. For example, it is possible to prepare a simulation environment or the like dedicated to optimization of the cost function in such a manner that the degree of approach to the destination is improved, for example. The same applies to the other evaluation parameters.

Note that, it is possible to do simulation including information regarding the type (brand) of the vehicle 10. In other words, it is also possible to do simulation by taking into consideration the actual size, performance, and the like of the vehicle 10. On the other hand, it is also possible to do simulation by focusing on courses only.

Alternatively, any method may be adopted as a method for optimizing the cost function. For example, the cost function may be optimized through the cross-entropy method, adversarial learning, or the like.

The cost function evaluation unit 34 evaluates the optimized cost function. For example, high scores are given to cost functions capable of calculating appropriate courses in the respective simulations. In addition, high scores are also given to cost functions that achieve high performance on the basis of the evaluation parameters of the user. The cost function evaluation unit 34 decides a true cost function on the basis of the scores given to the cost functions, for example. Note that, the method of evaluating the cost functions and the method of deciding the true cost function are not limited. Any method may be adopted.

In addition, it is also possible to calculate a cost function specific to each region. In other words, a true cost function may be calculated with regard to each of different regions. For example, a true cost function may be selected with regard to each city in the world such as Tokyo, Beijing, India, Paris, London, New York, San Francisco, Sydney, Moscow, Cairo, Johannesburg, Buenos Aires, or Rio de Janeiro. In other words, a true cost function may be calculated in accordance with a characteristic of a region such as desert, forest, snowfield, or plain. Of course, it is also possible to generate a cost function that is usable worldwide.

For example, it is possible to calculate a true cost function with regard to each region by appropriately selecting training data corresponding to the region. For example, it is possible to generate training data for each region on the basis of movement information collected from vehicles 10 that have moved in a calculation target region. Alternatively, any method may be adopted.

In addition, it is also possible to generate a true function with regard to each evaluation parameter of the user. Subsequently, each vehicle 10 may be capable of selecting a cost function corresponding to a certain evaluation parameter.

As illustrated in FIG. 1, a true cost function calculated by the server apparatus 30 is transmitted to each vehicle 10 via the network 20. Of course, it is also possible to appropriately update the cost function and then transmit it to the vehicle 10. In addition, the calculated cost function may be installed at factory shipment.

The route planning unit 161 of the vehicle 10 calculates a course on the basis of the received cost function. According to the present embodiment, the autonomous driving control unit 112 illustrated in FIG. 3 functions as an acquisition unit that acquires a cost function related to movement of a mobile object, the cost function having been calculated through the inverse reinforcement learning on the basis of training data including course data related to a course along which the mobile object has moved. In addition, the route planning unit 161 functions as a course calculation unit that calculates a course on the basis of the acquired cost function.

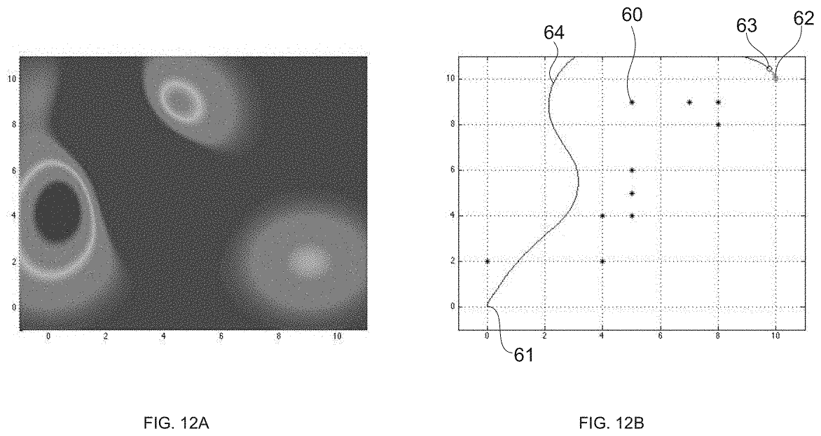

FIG. 11 and FIG. 12 are diagrams for describing evaluation made on the present technology. Learning and evaluation of cost functions according to the present technology were performed in dynamic environments with three different strategies. As the dynamic environments, an environment where obstacles move in a vertical direction, an environment where obstacles move in a horizontal direction, and a random environment are assumed. In addition, it is assumed that locations of the obstacles are randomly set within a range.

In this evaluation, multiple dots 60 representing the obstacles are moved in a left-right direction, an up-down direction, and a random direction (these directions correspond to the three strategies described above) on a screen. In this case, an evaluation is made by moving a movement target object 63 from a starting point 61 to a destination 62.

FIG. 11 is diagrams illustrating a case where a path (course) is calculated by means of a cost map (cost function) in which a simple circumradius is used and the circumradius is set as a fixed safety margin. FIG. 11A is a cost map generated at a certain timing. FIG. 11B is a diagram illustrating a track 64 along which the movement target object 63 has moved from the starting point 61 to the destination 62 in the case where the multiple dots 60 representing the obstacles have moved from left to right. The movement target object 63 could not pass through gaps in the multiple dots 60, the movement target object 63 has turned multiple times, and it takes a long time to arrive at the destination.

FIG. 12 is diagrams illustrating a case where a path (course) is calculated by means of a cost function (cost map) according to the present technology. A user uses a controller and moves the movement target object 63 to the destination while avoiding the dots 60 that are moving on the screen. The cost function is calculated through the GPIRL on the basis of training data including such course data. In this case, as illustrated in FIG. 12A, a cost map in which safety margins are optimized is generated. As illustrated in FIG. 12B, this allows the movement target object 63 to pass through gaps between the dots 60 and move to the destination 62. In other words, according to the present technology, it is possible to sequentially change the cost map in accordance with the strategies and arrive at the destination within a short time.

As described above, the movement control system 500 according to the present embodiment calculates the cost function through the inverse reinforcement learning on the basis of the training data. This makes it possible to achieve the flexible movement control tailored to a movement environment.

With regard to autonomous driving control over the mobile object, it is important to find a cost function for generating an optimal course. Conventionally, an experimenter has often designed the cost function in general. In particular, a certain circumradius has often been set for obstacles. However, when the certain circumradius is simply set, sometimes it may be impossible to move and it may take time to arrive at a goal in a situation where obstacles are overcrowding.

For example, various movement environment such as an environment where vehicles are overcrowding, a special environment like a roundabout, an environment including much disturbance, and an environment with high uncertainty (an environment where it is difficult to look around) are considered as the movement environment where the vehicle 10 moves. It is very difficult to design a cost function compatible with the various movement environment as described above while a parameter such as the circumradius is fixed in advance.

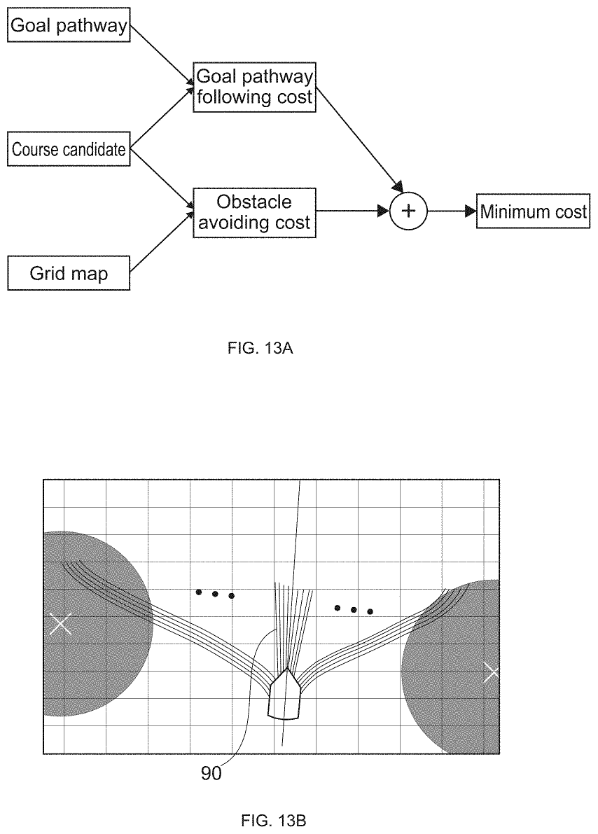

FIG. 13 is diagrams for describing a course calculation method according to a comparative example. For example, as illustrated in FIG. 13, so many course candidates 90 are calculated. Next, a goal pathway following cost and an obstacle avoiding cost are calculated with regard to each of the course candidates 90. A course candidate 90 whose total of the goal pathway following cost and the obstacle avoiding cost that have been calculated is minimum is calculated as a course along which the mobile object should move. For example, even in the case of using such a method, weights or the like to be attached to the goal pathway following cost and the obstacle avoiding cost are designed in advance, and it is difficult to deal with various kinds of movement environments. For example, if the obstacle avoiding cost is increased unnecessarily, sometimes the vehicle may get stuck in an environment where vehicles are overcrowding, or the like.

According to the present embodiment, it is possible to learn a cost function by using the training data. This makes it possible to optimize parameters such as the safety margins in accordance with a movement environment. This makes it possible to calculate cost functions tailored to various kinds of environment, and this makes it possible to achieve flexible movement control in accordance with the environments.

In addition, it is also possible to relearn a cost function on the basis of evaluation parameters of a user. This makes it possible to control movement with very high accuracy that is desired by the user. In addition, the vehicle 10 calculates a course to a destination by inputting a state S into the cost function. This makes it possible to reduce processing time and processing load. In addition, even in the case of an unexperienced environment, a cost function is calculated on the basis of an experience (training data) acquired by another vehicle. This makes it possible to appropriately move the vehicle 10 even in the case of no map information or the like.

Note that, it is possible for the user to appropriately set the parameters that define the cost function. Therefore, the parameters that define the cost function may be referred to as the evaluation parameters.

### Other Embodiments

The present technology is not limited to the above-described embodiment. Various other embodiments are possible.

According to the present technology, it is also possible to generate a cost map defined by safety margins based on a movement direction of a mobile object. For example, a matrix including eigenvalues that are values different from each other is adopted as the covariance matrix Σ of the two-dimensional normal distribution. Next, the safety margins are defined in such a manner that a larger eigenvalue corresponds to the movement direction. This makes it possible to set the safety margin having an oval shape (elliptical shape) that extends along the movement direction (whose longitudinal direction corresponds to the movement direction).

For example, the freeway is an environment where only vehicles exist around the movement target object, their movement directions are constant, and uncertainty is low. In addition, it is necessary to set speed of the movement target object in such a manner that the speed is similar to speed of surrounding vehicles. A cost function where an eigenvalue corresponds to a movement direction is calculated as a cost function suitable for such an environment. In addition, it is also possible to optimize the size of a safety margin by weighting the eigenvalue in accordance with the speed.

The cost map (cost function) based on the normal distribution has been described above. However, the present technology is also applicable to a cost map (cost function) based on another type of probability distribution. In addition, it is also possible to calculate a cost function by means of an inverse reinforcement learning algorithm other than the GPIRL.

Note that, the generation of a cost map (cost function) based on the probability distribution is also a technology that has been newly developed by the present inventor. The technology that has been newly developed includes any information processing apparatus including an acquisition unit that acquires information related to movement of a mobile object, and a generation unit that generates a cost map based on a probability distribution on the basis of the acquired information related to the movement of the mobile object. By means of such an information processing apparatus, it is possible to achieve the flexible movement control tailored to a movement environment. Of course, the server apparatus illustrated in FIG. 1 and the like are also included in the technology that has been newly developed.

The example in which simulation is done by using the virtual space has been described above. The present technology is not limited thereto. It is also possible to transmit surrounding information detected by the vehicle to the server apparatus, and do the simulation on the basis of the actual surrounding information. This makes it possible to optimize a cost function in accordance with an actual surrounding situation.

According to the above-described embodiment, the server apparatus calculates the cost function. However, a vehicle control system installed in the vehicle may be configured as the information processing apparatus according to the present technology, and may execute the information processing method according to the present technology. In other words, the vehicle may calculate the cost function through the inverse reinforcement learning based on the training data.

The present technology is applicable to control over various kinds of mobile objects. For example, the present technology is applicable to movement control over cars, electric cars, hybrid electric cars, motorcycles, bicycles, personal transporters, airplanes, drones, ships, robots, heavy equipment, agricultural machinery (tractors), and the like.

The information processing method and the program according to the present technology may be executed not only in a computer system configured by a single computer but also in a computer system in which a plurality of computers cooperatively operate. It should be noted that in the present disclosure, the system means an aggregate of a plurality of components (apparatus, module (parts), and the like) and it does not matter whether or not all the components are housed in the same casing. Therefore, a plurality of apparatuses housed in separate casings and connected to one another via a network and a single apparatus having a plurality of modules housed in a single casing are both the system.

The execution of the information processing method and the program according to the present technology by the computer system includes, for example, both of a case where the acquisition of the training data, the calculation of the cost function, and the like are executed by a single computer and a case where those processes are executed by different computers. Further, the execution of the respective processes by a predetermined computer includes causing the other computer to perform some or all of those processes and acquiring results thereof.

That is, the information processing method and the program according to the present technology are also applicable to a cloud computing configuration in which one function is shared and cooperatively processed by a plurality of apparatuses via a network.

The respective configurations, the processing flows, and the like of the server apparatus, the vehicle, etc. described with reference to the drawings are merely one embodiment. Any modification can be made without departing from the gist of the present technology. In other words, it is possible to adopt any other configuration, algorithm, or the like to achieve the present technology.

Out of the feature parts according to the present technology described above, at least two feature parts can be combined. That is, the various feature parts described in the embodiments may be arbitrarily combined irrespective of the embodiments. Further, various effects described above are merely examples and are not limited, and other effects may be exerted.

Note that, the present technology may also be configured as below.

(1) An information processing apparatus including:

an acquisition unit that acquires training data including course data related to a course along which a mobile object has moved; and

a calculation unit that calculates a cost function related to movement of the mobile object through inverse reinforcement learning on the basis of the acquired training data.

(2) The information processing apparatus according to (1) or (2), in which

the cost function makes it possible to generate a cost map by inputting information related to the movement of the mobile object.

(3) The information processing apparatus according to (2) or (3), in which

the information related to the movement includes at least one of a position of the mobile object, surrounding information of the mobile object, or speed of the mobile object.

(4) The information processing apparatus according to any one of (1) to (3), in which

the calculation unit calculates the cost function in such a manner that a predetermined parameter for defining the cost map is variable.

(5) The information processing apparatus according to (4), in which

the calculation unit calculates the cost function in such a manner that a safety margin is variable.

(6) The information processing apparatus according to any one of (1) to (5), further including

an optimization processing unit that optimizes the calculated cost function through simulation.

(7) The information processing apparatus according to (6), in which

the optimization processing unit optimizes the cost function on the basis of the acquired training data.

(8) The information processing apparatus according to (6) or (7), in which

the optimization processing unit optimizes the cost function on the basis of course data generated through the simulation.

(9) The information processing apparatus according to any one of (6) to (8), in which

the optimization processing unit optimizes the cost function by combining the acquired training data with course data generated through the simulation.

(10) The information processing apparatus according to any one of (6) to (9), in which

the optimization processing unit optimizes the cost function on the basis of an evaluation parameter set by a user.

(11) The information processing apparatus according to (10), in which

the optimization processing unit optimizes the cost function on the basis of at least one of a degree of approach to a destination, a degree of safety regarding movement, or a degree of comfort regarding the movement.

(12) The information processing apparatus according to any one of (1) to (11), in which

the calculation unit calculates the cost function through Gaussian process inverse reinforcement learning (GPIRL).

(13) The information processing apparatus according to any one of (1) to (12), in which

the cost function makes it possible to generate a cost map based on a probability distribution.

(14) The information processing apparatus according to (13), in which

the cost function makes it possible to generate a cost map based on a normal distribution, and

the cost map is defined by a safety margin corresponding to an eigenvalue of a covariance matrix.

(15) The information processing apparatus according to (14), in which

the cost map is defined by a safety margin based on a movement direction of the mobile object.

(16) The information processing apparatus according to any one of (1) to (15), in which

the calculation unit is capable of calculating the respective cost functions corresponding to different regions.

(17) An information processing method that causes a computer system to:

acquire training data including course data related to a course along which a mobile object has moved; and

calculate a cost function related to movement of the mobile object through inverse reinforcement learning on the basis of the acquired training data.

(18) A program that causes a computer system to execute:

a step of acquiring training data including course data related to a course along which a mobile object has moved; and

a step of calculating a cost function related to movement of the mobile object through inverse reinforcement learning on the basis of the acquired training data.

(19) A mobile object including:

an acquisition unit that acquires a cost function related to movement of the mobile object, the cost function having been calculated through inverse reinforcement learning on the basis of training data including course data related to a course along which the mobile object has moved; and

a course calculation unit that calculates a course on the basis of the acquired cost function.

(20) An information processing apparatus including:

an acquisition unit that acquires information related to movement of a mobile object; and

a generation unit that generates a cost map based on a probability distribution on the basis of the acquired information related to the movement of the mobile object.

### REFERENCE SIGNS LIST

10 vehicle
20 network
25 database
30 server apparatus
31 training data acquisition unit
32 cost function calculation unit
33 optimization processing unit
34 cost function evaluation unit
40, 50 cost map
45 safety margin
47, 51 course
100 vehicle control system
500 movement control system

1. An information processing apparatus comprising:
an acquisition unit that acquires training data including course data related to a course along which a mobile object has moved; and
a calculation unit that calculates a cost function related to movement of the mobile object through inverse reinforcement learning on a basis of the acquired training data.

2. The information processing apparatus according to claim 1, wherein
the cost function makes it possible to generate a cost map by inputting information related to the movement of the mobile object.

3. The information processing apparatus according to claim 2, wherein
the information related to the movement includes at least one of a position of the mobile object, surrounding information of the mobile object, or speed of the mobile object.

4. The information processing apparatus according to claim 2, wherein
the calculation unit calculates the cost function in such a manner that a predetermined parameter for defining the cost map is variable.

5. The information processing apparatus according to claim 4, wherein
the calculation unit calculates the cost function in such a manner that a safety margin is variable.

6. The information processing apparatus according to claim 1, further comprising
an optimization processing unit that optimizes the calculated cost function through simulation.

7. The information processing apparatus according to claim 6, wherein
the optimization processing unit optimizes the cost function on a basis of the acquired training data.

8. The information processing apparatus according to claim 6, wherein
the optimization processing unit optimizes the cost function on a basis of course data generated through the simulation.

9. The information processing apparatus according to claim 6, wherein
the optimization processing unit optimizes the cost function by combining the acquired training data with course data generated through the simulation.

10. The information processing apparatus according to claim 6, wherein
the optimization processing unit optimizes the cost function on a basis of an evaluation parameter set by a user.

11. The information processing apparatus according to claim 10, wherein
the optimization processing unit optimizes the cost function on a basis of at least one of a degree of approach to a destination, a degree of safety regarding movement, or a degree of comfort regarding the movement.

12. The information processing apparatus according to claim 1, wherein
the calculation unit calculates the cost function through Gaussian process inverse reinforcement learning (GPIRL).

13. The information processing apparatus according to claim 1, wherein
the cost function makes it possible to generate a cost map based on a probability distribution.

14. The information processing apparatus according to claim 13, wherein
the cost function makes it possible to generate a cost map based on a normal distribution, and
the cost map is defined by a safety margin corresponding to an eigenvalue of a covariance matrix.

15. The information processing apparatus according to claim 14, wherein
the cost map is defined by a safety margin based on a movement direction of the mobile object.

16. The information processing apparatus according to claim 1, wherein
the calculation unit is capable of calculating the respective cost functions corresponding to different regions.

17. An information processing method that causes a computer system to:
acquire training data including course data related to a course along which a mobile object has moved; and
calculate a cost function related to movement of the mobile object through inverse reinforcement learning on a basis of the acquired training data.

18. A program that causes a computer system to execute:
a step of acquiring training data including course data related to a course along which a mobile object has moved; and
a step of calculating a cost function related to movement of the mobile object through inverse reinforcement learning on a basis of the acquired training data.

19. A mobile object comprising:
an acquisition unit that acquires a cost function related to movement of the mobile object, the cost function having been calculated through inverse reinforcement learning on a basis of training data including course data related to a course along which the mobile object has moved; and
a course calculation unit that calculates a course on a basis of the acquired cost function.

20. An information processing apparatus comprising:
an acquisition unit that acquires information related to movement of a mobile object; and
a generation unit that generates a cost map based on a probability distribution on a basis of the acquired information related to the movement of the mobile object.
